(19) United States
(12) Patent Application Publication
(10) Pub. No.: US 2018/0033358 A1
(43) Pub. Date: Feb. 1, 2018

(54) ELECTRIC LIGHTING DEVICE WITH DISPLAY

(71) Applicant: Luminara Worldwide, LLC, Eden Prairie, MN (US)

(72) Inventor: Douglas Patton, Irvine, CA (US)

(21) Appl. No.: 15/660,818

(22) Filed: Jul. 26, 2017

Related U.S. Application Data
(60) Provisional application No. 62/367,027, filed on Jul. 26, 2016.
(60) Provisional application No. 62/402,175, filed on Sep. 30, 2016.
(60) Provisional application No. 62/413,138, filed on Oct. 26, 2016.

(51) Int. Cl. G09G 3/00; G09G 3/3225

(52) U.S. Cl. CPC G09G 3/008; G09G 3/3225

(57) ABSTRACT

Various embodiments of electric lighting devices are described that have a display screen configured to display one or more images or video of a flame. The devices have a housing with the display screen extending from the upper surface. A circuit board can be disposed within the housing and connected to the display screen to thereby power and send data to the screen. Where the display screen is transparent when off, this allows the display screen to be less visible to users.

This application claims priority to U.S. provisional application having Ser. No. 62/367,027 filed on Jul. 26, 2016. This application also claims the benefit of priority to U.S. provisional application having Ser. No. 62/402,175 filed on Sep. 30, 2016, and U.S. provisional application having Ser. No. 62/413,138 filed on Oct. 26, 2016. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is electric lighting devices, and in particular, electric candles.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Various electric lights are known in the art. See, e.g., U.S. Pat. No. 8,132,936 to Patton et al., U.S. Pat. No. 8,070,319 to Schnuckle et al., U.S. Pat. No. 7,837,355 to Schnuckle et al., U.S. Pat. No. 7,261,455 to Schnuckle et al., U.S. Pat. No. 7,159,994 to Schnuckle et al., US 2011/0127914 to Patton et al., U.S. Pat. No. 7,350,720 to Jaworski et al.; US 2005/0285538 to Jaworski et al. (publ. December 2005); U.S. Pat. No. 7,481,571 to Bistritzky et al.; US 2008/0031784 to Bistritzky et al. (publ. February 2008); US 2006/0125420 to Boone et al. (publ. June 2006); US 2007/0127249 to Medley et al. (publ. June 2007); US 2008/0150453 to Medley et al. (publ. June 2008); US 2005/0169666 to Porchia, et al. (publ. August 2005); U.S. Pat. No. 7,503,668 to Porchia, et al.; U.S. Pat. No. 7,824,627 to Michaels, et al.; US 2006/0039835 to Nottingham et al. (publ. February 2006); US 2008/0038156 to Jaramillo (publ. February 2008); US 2008/0130266 to DeWitt et al. (publ. June 2008); US 2012/0024837 to Thompson (publ. February 2012); US 2011/0134628 to Pestl et al. (publ. June 2011); US 2011/0027124 to Albee et al. (publ. February 2011); US 2012/0020052 to McCavit et al. (publ. January 2012); US 2012/0093491 to Browder et al. (publ. April 2012); and US 2014/0218903 to Sheng. However, all of these products suffer from one or more disadvantages.

Flat screen displays, such as liquid crystal displays (LCDs) organic light emitting diode (OLED) displays, and electroluminescent (EL) displays have been continuously improved and now are commonly used in televisions and other devices. However, such components have not been used in consumer products such as electric candles for a variety of reasons.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

However, there is still a need in the art for improved electric candles and other lighting devices that generate a flickering flame effect.

### SUMMARY OF THE INVENTION

The present invention provides apparatus, systems, and methods in which an electronic lighting device (e.g., an artificial candle) comprises a display structure that simulates a real candle flame, and is preferably housed in a traditional candle body. In particular, electronic lighting devices are described that utilize a transparent or translucent flat or curved display to present images or video of a real, moving flame.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a vertical cross-section view of one embodiment of an electronic lighting device.

FIG. 1B is a top view of the circuit board of the device of FIG. 1A.

FIG. 2A is a vertical cross-section view of another embodiment of an electronic lighting device.

FIG. 2B is a top view of the circuit board of the device of FIG. 2A.

FIG. 3 is a vertical cross-section view of third embodiment of an electronic lighting device.

FIG. 4 illustrates one embodiment of an electronic lighting device that can communicate with a computing device via a wired or wireless connection.

FIG. 5 illustrates another embodiment of an electronic lighting device that can communicate with a computing device via a wired or wireless connection to vary the flame shown on the display.

FIGS. 6A-6B are front and side vertical cross-section views, respectively, of another embodiment of an electronic lighting device.

FIG. 7A is a front, vertical cross-section view of another embodiment of an electronic lighting device, and FIGS. 7B-7C are side vertical cross-section views of the device of FIG. 7A showing the display in a normal and retracted view.

FIG. 8 is a front view of yet another embodiment of an electronic lighting device.

FIGS. 9A-9B are perspective views of another embodiment of an electronic lighting device.

FIGS. 10A-10F are snap-shots of another embodiment of an electronic lighting device having a display screen in various states. FIGS. 10A and 10F illustrate the display screen in an off condition. FIG. 10B illustrates the display screen in an initial, “on” condition having an image of a wick. FIGS. 10C-10E illustrate the display screen having images of a flame.

FIGS. 11A-11B are schematic views of one embodiment of an electronic lighting device having a retractable display screen in an extended and retracted state, respectively.

FIGS. 12A-12B are schematic views of one embodiment of an electronic lighting device having a retractable display screen in an extended and retracted state, respectively.

FIG. 13A is a cross-section, schematic view of one embodiment of an electronic lighting device having a rotatable display screen.

FIGS. 13B-13D are top, schematic views of the lighting device of FIG. 13A.

FIG. 14A is a cross-section, schematic view of an embodiment of an electronic lighting device having a moveable display screen.

FIGS. 14B-14D are top, schematic views of the lighting device of FIG. 14A.

FIG. 15A is a cross-section, schematic view of another embodiment of an electronic lighting device having a moveable display screen.

FIGS. 15B-15C are top, schematic views of the lighting device of FIG. 15A.

FIGS. 16A-16B are perspective and side views, respectively, of one embodiment of an electronic lighting device having a display screen disposed about an exterior of the housing.

FIGS. 17A-17B are perspective and side views, respectively, of another embodiment of an electronic lighting device having a display screen disposed about an exterior of the housing.

FIGS. 18A-18B are perspective views of another embodiment of an electronic lighting device having a display screen disposed about an exterior of the housing.

FIGS. 19A-19C are top, side, and isometric views, respectively, of another embodiment of an electronic lighting device having a curved display screen.

FIG. 19D is a side view of the device of FIG. 19A showing the flexibility of the screen.

FIGS. 20A-20C are top, side, and perspective views, respectively, of another embodiment of an electronic lighting device having a cylindrical display screen.

FIG. 21 is an embodiment of a circuit diagram for display electronics for a display screen.

FIG. 22 is another embodiment of a circuit diagram for display electronics for a display screen.

FIG. 23 is a schematic of one embodiment of a display screen for an electric lighting device.

FIG. 24 is a time lapse showing still images of a video of a candle that is lit.

FIG. 25 is a side view of another embodiment of an electronic lighting device having a sail switch.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

One should appreciate that the disclosed subject matter provides many advantageous technical effects including providing various designs of an artificial candle that simulate the appearance of a real flame. Thus, many drawbacks of conventional methods of providing an artificial candle can be reduced, and even possibly eliminated, by the disclosed subject matter.

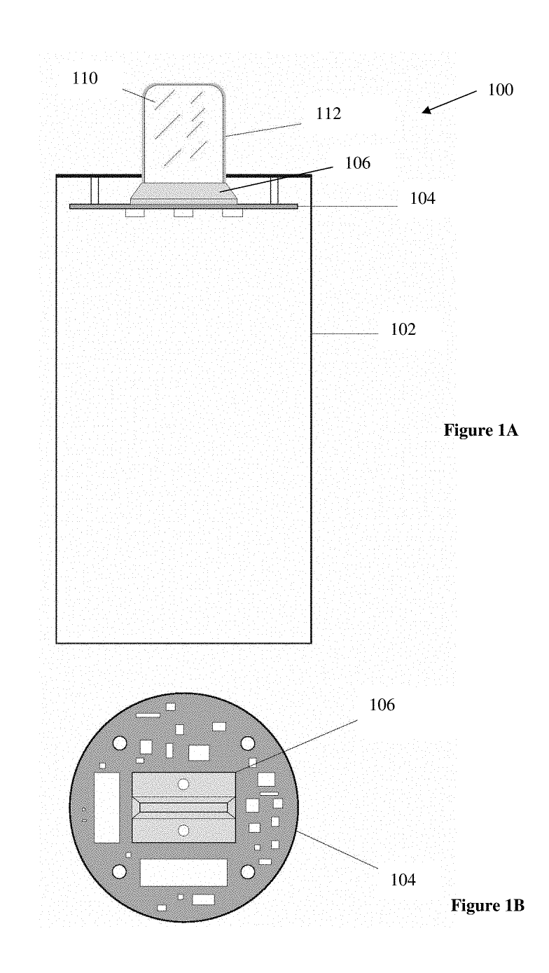

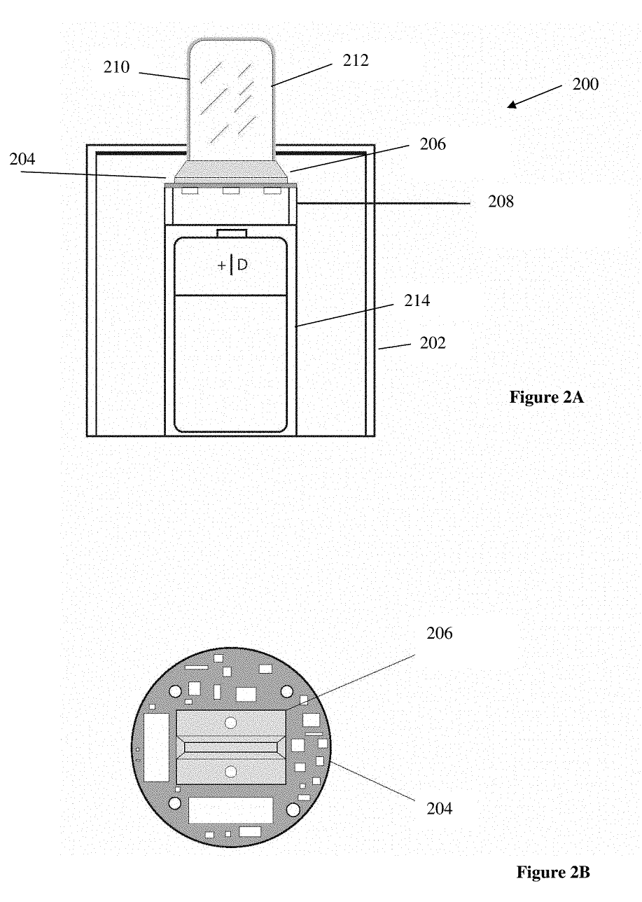

FIGS. 1A-1B illustrate one embodiment of an electric lighting device 100 having a housing 102. A circuit board (PCB) 104 is disposed within the housing 102, and fixed in place relative to the housing 102. Although shown mounted to the top surface of the housing 102, it is contemplated that the PCB 104 could alternatively be supported from below such as shown in FIG. 2A.

Preferably, the PCB 104 includes a support 106 for a display screen 110 that is integral with the PCB 104. However, it is contemplated that the support 106 could be affixed or coupled to the PCB 104. The support 106 is configured to secure the screen 110 in place while allowing for, or providing, electrical and data connections between the screen 100 and PCB 104.

The display screen 110 can be mounted in a display screen holder 112 that can act as a support and/or protector for the display screen 110, as well as prevent light from escaping from the sides of the display screen where desired.

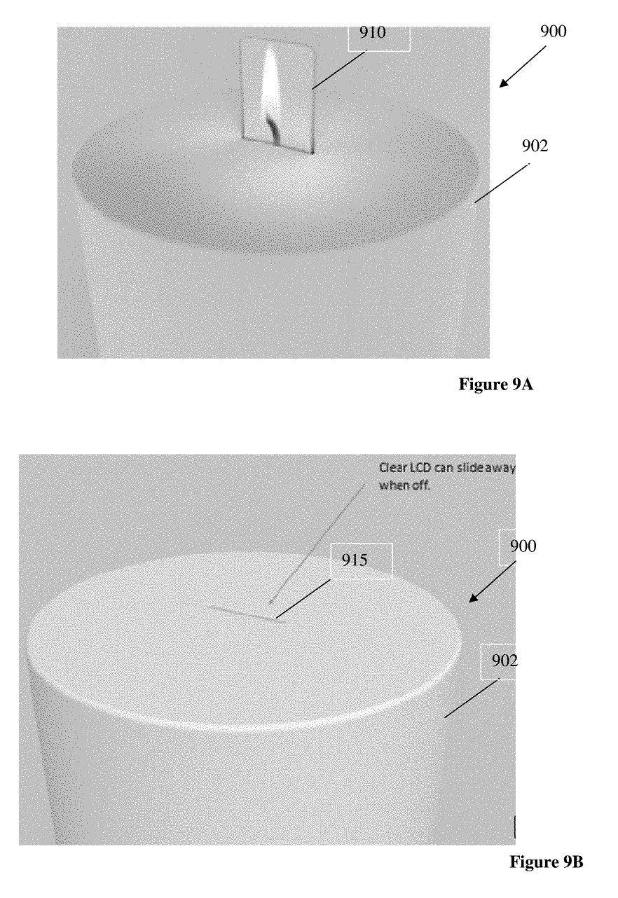

Additional detail concerning the display screen 110 and its associated hardware can be found below in the discussion referencing FIG. 9. Such discussion is incorporated herein by reference.

FIGS. 2A-2B illustrate another embodiment of an electric lighting device 200 having a housing 202. A circuit board (PCB) 204 is disposed within the housing 202, and fixed in place relative to the housing 202. The PCB 204 can be supported from below and affixed to or otherwise coupled to a battery compartment, for example. As shown in FIG. 2A, the PCB 204 can be disposed on a spacer 208 that is disposed on the battery compartment 214.

Preferably, the PCB 204 includes a support 206 for a display screen 210 that is integral with the PCB 204. However, it is contemplated that the support 206 could be affixed or coupled to the PCB 204. The support 206 is configured to secure the screen 210 in place while allowing for, or providing, electrical and data connections between the screen 200 and PCB 204. With respect to the remaining numerals in FIGS. 2A and 2B, the same considerations for like components with like numerals of FIG. 1A and FIG. 1B apply, respectively.

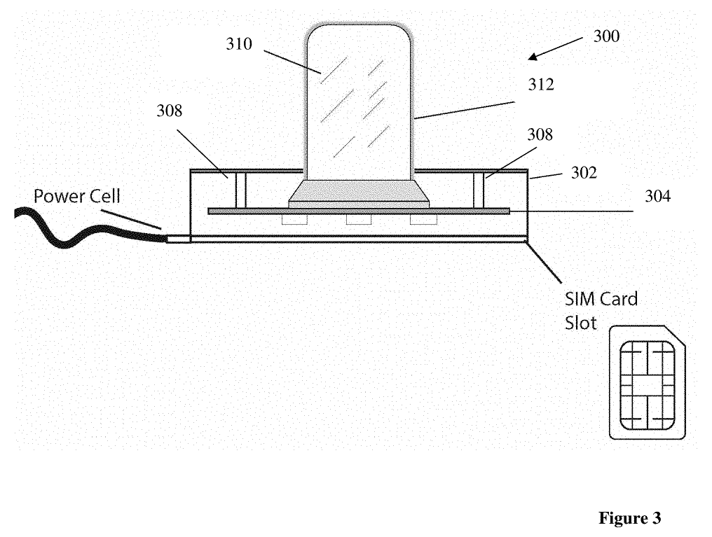

FIG. 3 illustrates another embodiment of an electric lighting device 300 having a housing 302. A circuit board (PCB) 304 is disposed within the housing 302, and fixed in place relative to the housing 302. The PCB 304 can be supported from above or below. As shown in FIG. 3, the PCB 304 can be supported by spacers 308 that are coupled to an upper surface of housing 302. With respect to the remaining numerals in FIG. 3, the same considerations for like components with like numerals of FIG. 1A apply.

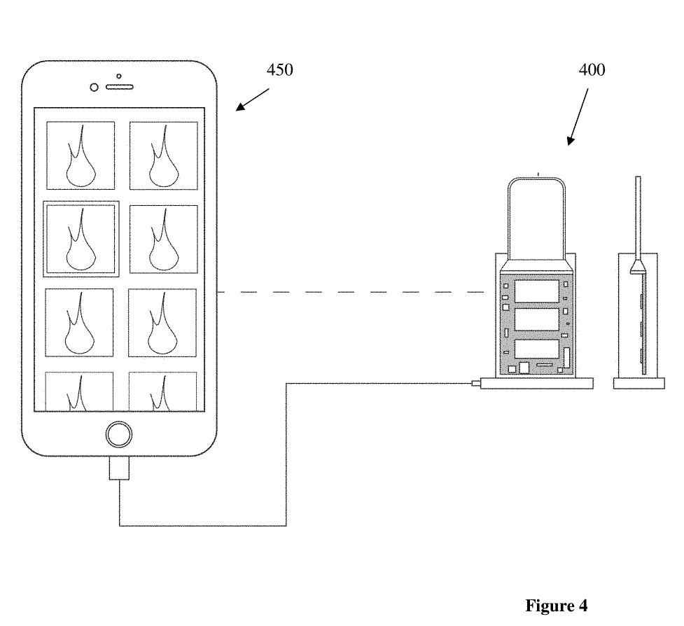

FIG. 4 illustrates another embodiment of an electric lighting device 400 that is configured to connect to an external computing device 450 via a wired or wireless connection. Exemplary wired connections include USB or other commercially suitable connections. Exemplary wireless connections include Bluetooth™, WIFI, and any other commercially suitable connections.

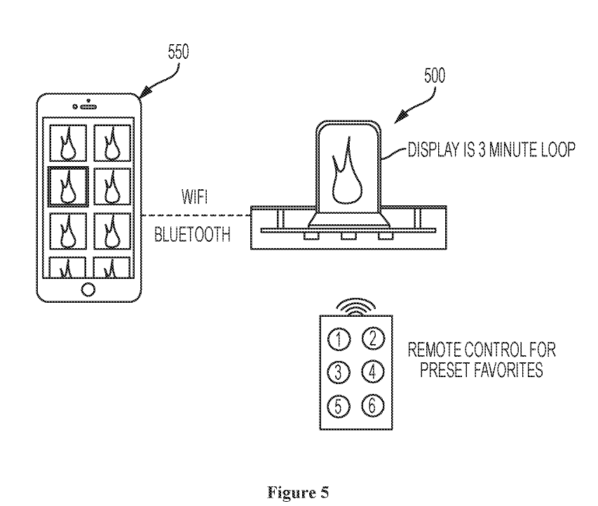

FIG. 5 illustrates another embodiment of an electric lighting device 500 that is configured to connect to an external computing device 550 via a wired or wireless connection. As shown in FIG. 5, the computing device 550 can be used to select a preferred flame effect to be displayed on the device 500. This could include a specific video of a moving flame, or varying characteristics of what is displayed including color of the flame, brightness, speed of movement and so forth. Contemplated computing devices include, for example, smart phones or smart watches or other wearables, but could also include a tablet PC, a laptop, or a desktop computer.

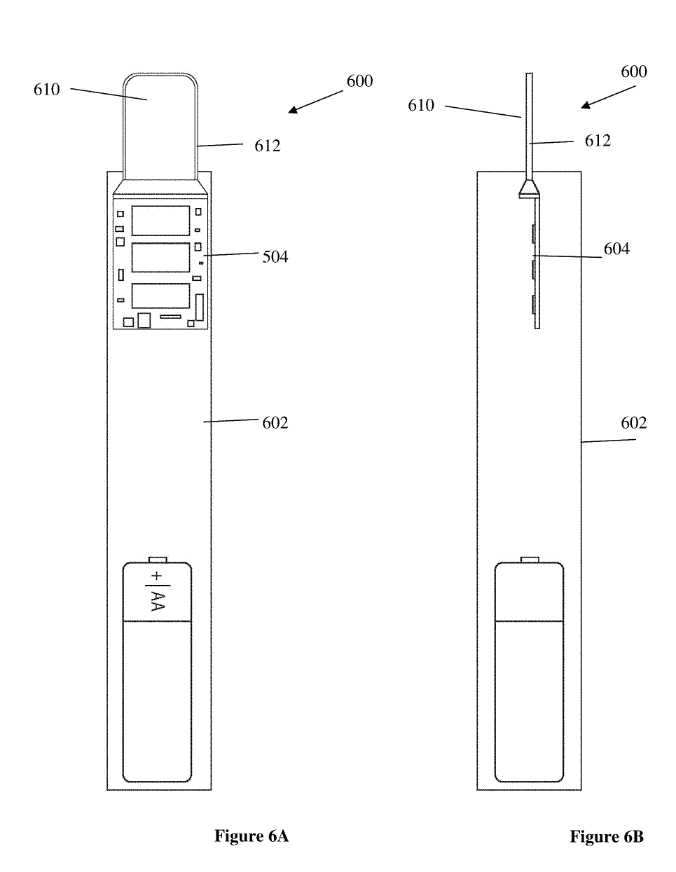

FIGS. 6A-6B illustrates another embodiment of an electric lighting device 600 having an elongated housing 602 resembling a taper candle. As discussed above, a PCB 604 can be disposed within the housing 602 and is preferably mounted in place relative to the housing. The PCB 604 could be secured to the housing via preformed supports on an interior surface of the housing, such as described in U.S. Patent Publication No. 2017/0038020 filed on May 26, 2016. Alternatively, the PCB 604 could be mounted from below or above via one or more injection molded piece, such as a spacer. With respect to the remaining numerals in FIGS. 6A and 6B, the same considerations for like components with like numerals of FIG. 1A applies.

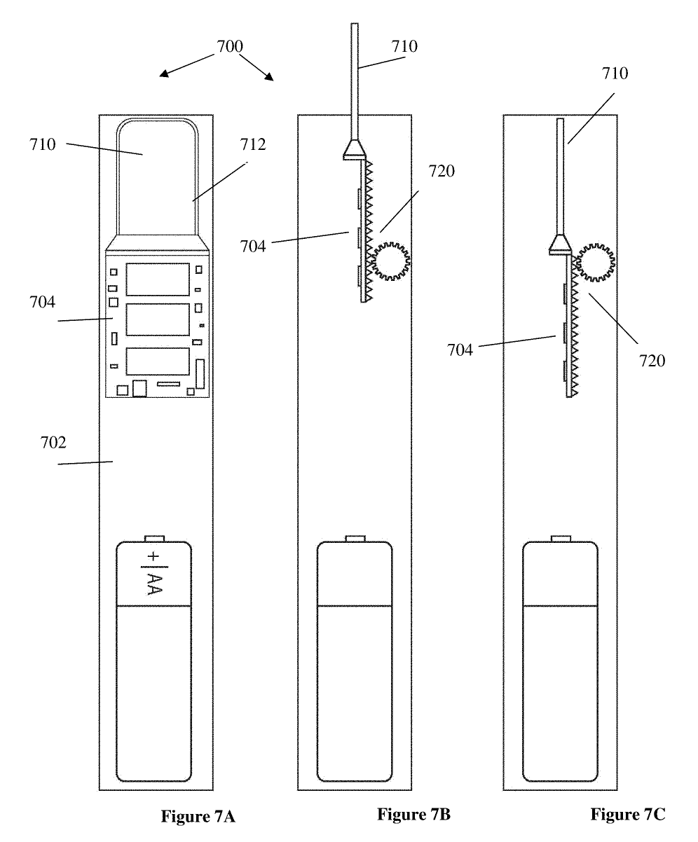

FIGS. 7A-7C illustrates another embodiment of an electric lighting device 700 having a retractable display screen 710. The display screen 710 is preferably connected with a rack and pinion system 720 or other height adjustment mechanism that allows for vertical movement of the display screen relative to the housing 702. In this manner, the display screen can be retracted within the housing 702, such as when the display screen is not in use or when the device 700 will be stored or moved. In some contemplated embodiments, the display screen 710 can be automatically retracted upon powering down of the device and/or when the device is tilted or knocked over, for example. This could be down via a simple circuit and/or the use of a sensor to detect when the device is not upright.

As shown in FIGS. 7B and 7C, the PCB 704 can include the rack on a first surface that can be moved as the pinion rotates.

an elongated housing 602 resembling a taper candle. As discussed above, a PCB 604 can be disposed within the housing 602 and is preferably mounted in place relative to the housing. The PCB 604 could be secured to the housing via preformed supports on an interior surface of the housing, such as described in U.S. Patent Publication No. 2017/0038020 filed on May 26, 2016. Alternatively, the PCB 604 could be mounted from below or above via one or more injection molded piece, such as a spacer. With respect to the remaining numerals in FIGS. 6A and 6B, the same considerations for like components with like numerals of FIG. 1A applies.

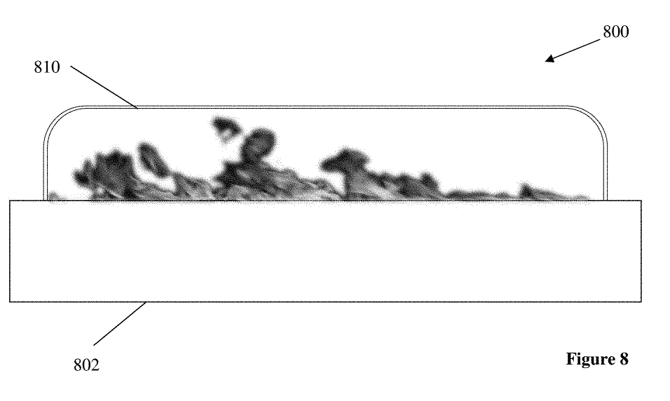

FIG. 8 illustrates another embodiment of an electric lighting device 800 having a display screen 810 that comprises an elongated display screen. It is contemplated that such devices could be larger in size, such as to simulate a fireplace or fire pit, for example.

FIGS. 9A-9B illustrate another embodiment of an electronic lighting device 900, here that has a housing 902 resembling a traditional wax candle and that is preferably at least partially composed of wax. A display screen 910 extends from an upper surface of the housing. In preferred embodiments, an image of a flame, or more preferably a video of a flame, can be displayed such that viewers of the device 900 appear to see a moving flame atop of the device. Although not required, it is contemplated that the display screen 910 can be retracted within the housing automatically via a rack and pinion system or manually such as by a user applying force to a top of the screen 910 until the screen is inserted within the housing 902. A latch could be used to keep the screen 910 within the housing until released, at which point a spring could be used to propel the screen 910 upwardly. FIG. 9B shows a slit 915 in the upper surface through which the display screen 910 can move.

Although the display screen 910 could be a monochrome transparent electroluminescent or similar display used to present a moving flame, preferred display screens are selected to allow for multiple colors to be displayed. The display screen 910 can be placed in a central area on an upper surface of the device's housing 902, with the display connector preferably located within the housing 902 and on the PCB, as discussed above with respect to FIGS. 1A-1B.

Preferred display screens are transparent such that they are less visible when the screen is in an “off” state, although translucent, partially transparent, or opaque screens are also contemplated. On the display screen, a realistic portrayal of a moving candle flame may be displayed.

In some contemplated embodiments, the display driver and associated electronics are located on the circuit board (PCB) inside the housing of the lighting device. The electronics and associated software are activated when the power switch is turned on, the remote control is operated, or the built-in timer cycles to a start time. Once energized, the MCU (microcontroller) begins executing its firmware program. The program accesses the memory (either internal or external) and begins sending data to a controller that processes the data and drives the display screen. Simultaneously, the EL bias voltage is applied to the Indium Tin Oxide (ITO) electrodes of the EL to produce photon output based upon the animation or video brightness and input from the (MCU) based upon the ambient light measuring photo transistor and software brightness algorithm. The display image is continually updated based upon the display refresh rate and video frame rate giving the appearance of a real candle flame moving and flickering. The displayed images are displayed as the video or animation information is processed and preferably starts over (loops) when the end of the animation or video information is reached.

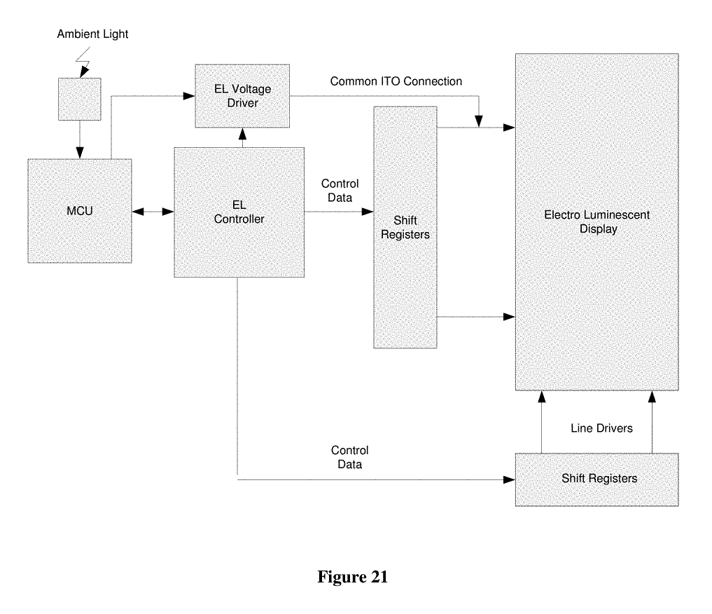

The diagram shown in FIG. 21 illustrates one embodiment of a schematic of the display electronics configuration for the display screen 910.

Preferred display screens are based upon color non-electroluminescent transparent display technology such as a transparent organic light emitting diode (TOLED) and variations such as transparent active matrix light emitting diode (TAMOLED), transparent passive matrix light emitting diode (TPMOLED), transparent polymer light emitting diodes (TPLED) and transparent flexible organic light emitting diode (TFOLED).

PMOLEDs have strips of cathode, organic layers and strips of anode. The anode strips are arranged perpendicular to the cathode strips. The intersections of the cathode and anode make up the pixels where light is emitted. External circuitry applies current to selected strips of anode and cathode, determining which pixels get turned on and which pixels remain off. The brightness of each pixel is proportional to the amount of applied current.

AMOLEDs have full layers of cathode, organic molecules and anode, but the anode layer overlays a thin film transistor (TFT) array that forms a matrix. The TFT array itself is the circuitry that determines which pixels get turned on to form an image.

PMOLEDs consume more power than other types of OLED, but are most efficient for text and icons and are best suited for small screens (2-3 inch diagonal). AMOLEDs consume less power than PMOLEDs because the TFT array requires less power than external circuitry. AMOLEDs also have faster refresh rates and are therefore often used in large-screen TVs, etc.

Transparent OLEDs have only transparent components (substrate, cathode and anode) and, when turned off, are up to 85 percent as transparent as their substrate. When a transparent OLED display is turned on, it allows light to pass in both directions. A transparent OLED display can be either active- or passive-matrix. This technology can be used for heads-up displays.

OLEDs are manufactured by printing organic molecules that emit colored light onto a substrate. OLEDs can be printed onto any substrate by an inkjet printer or by screen printing.

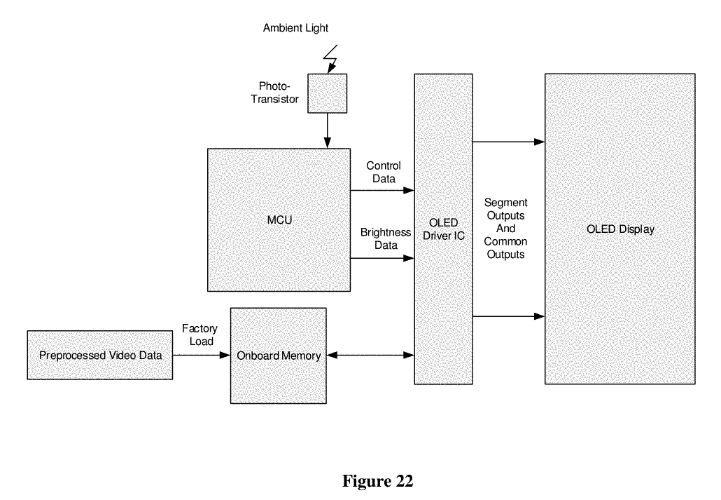

A flat or curved transparent color organic light emitting diode (OLED) or other display may be used to simulate the appearance of a candle flame by means of displaying a changing video image of a pre-recorded candle flame. The video file is preprocessed, using a proprietary method, to optimize power consumption and correct for the brightness non-linearity problem inherent in OLED displays. The video file is stored in onboard memory connected to the OLED display integrated circuit (IC). The OLED display IC processes the video file and distributes the images through the segment and common outputs to the OLED display. See diagram in FIG. 22.

Transparent OLED screens (or similar display technology) operate similarly to the EL display embodiment, in that the display driver and associated electronics is located on a printed circuit board (PCB) inside the device's housing. The electronics and associated software are activated when the power switch is turned on, the remote control is operated or the built in timer cycles to a start time. Once energized the MCU (microcontroller) begins executing its firmware program. The program commands the OLED Driver IC to process the video or animation information in the external memory. The OLED Driver IC then processes the data and drives the display based upon the animation or video content and input from the (MCU). The brightness of the display is controlled based animation or video and the ambient light measuring photo transistor and software brightness algorithm (see below). The display image is continually updated based upon the display refresh rate and video frame rate giving the appearance of a real candle flame moving and flickering. The displayed images are displayed as the video or animation information is processed and starts over when the end of the animation or video information is reached.

Some advantages of OLED displays are that the individual OLED pixels emit their own individual light (photons) and do not require a backlight or other light source. This provides the OLED display the ability to conserve power by varying the power to each pixel and only illuminating the needed pixels. In contrast, other technologies such as LCD require a backlight to illuminate all pixels regardless of whether they are needed.

The inventors have further found that power consumption of the display can be reduced by adding a phototransistor to detect an ambient light level. Based upon a unique proprietary non-linear software algorithm, power to the TOLED pixels can be reduced when the ambient light level is lower and maximum brightness is not necessary.

It is further contemplated that a user can download various flame movies to the lighting device via a wired or wireless connection, and could select one or more preloaded flame or other videos or images via a user interface. In preferred embodiments, the user interface comprises a webpage or a mobile application that directs a device to transmit one or more commands to the lighting device, preferably via a wireless connection (e.g., Bluetooth, WIFI, etc.).

Although shown as used with a pillar candle shape, it is contemplated that the inventions discussed herein could be used with differently sized and shaped lighting devices, including a taper candle, for example. It is further contemplated that a lighting device could have two or more display screens extending from an upper surface of the housing, which may be separately movable and/or controllable.

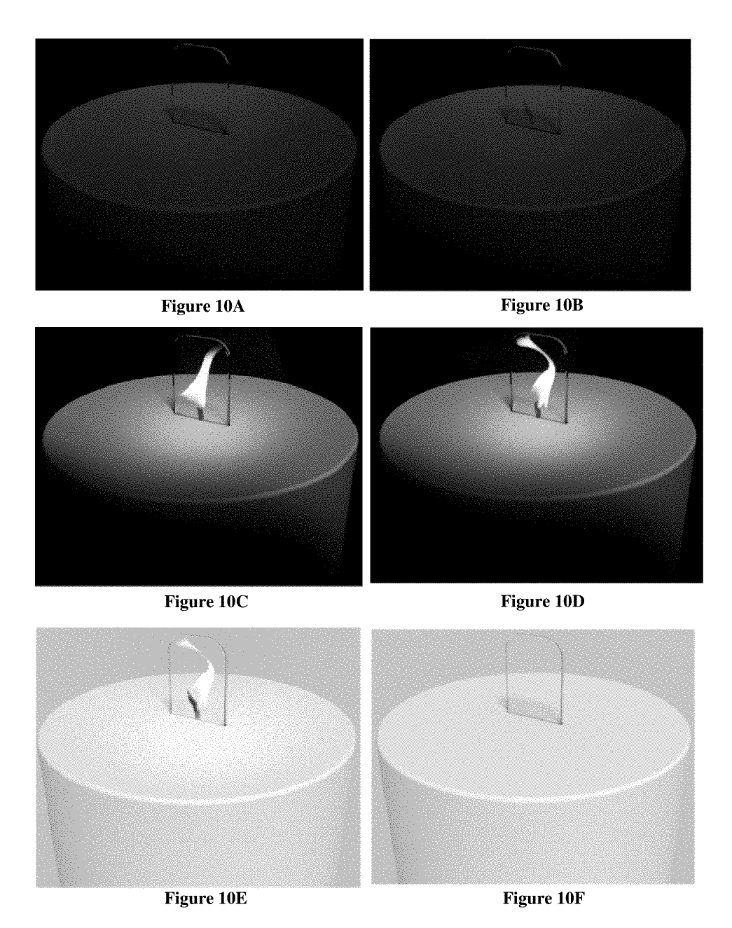

FIGS. 10A-10F illustrate a set of snap-shots of an electronic lighting device having a display screen configured to display a video of a flame, such that a moving flame appears at an upper surface of the device. FIG. 10A depicts the display screen in an “off” state in which no image or video is shown. In such state, the display screen is preferably transparent to limit the visibility of the display screen. As shown in FIG. 10B, when the device is first illuminated or optionally even in an “off” state, an image or video of a wick can be shown. As shown in FIGS. 10C-10E, a video of a flame can be shown on the wick, which thereby presents a moving flame. Finally, FIG. 10F shows the display screen in the “off” state.

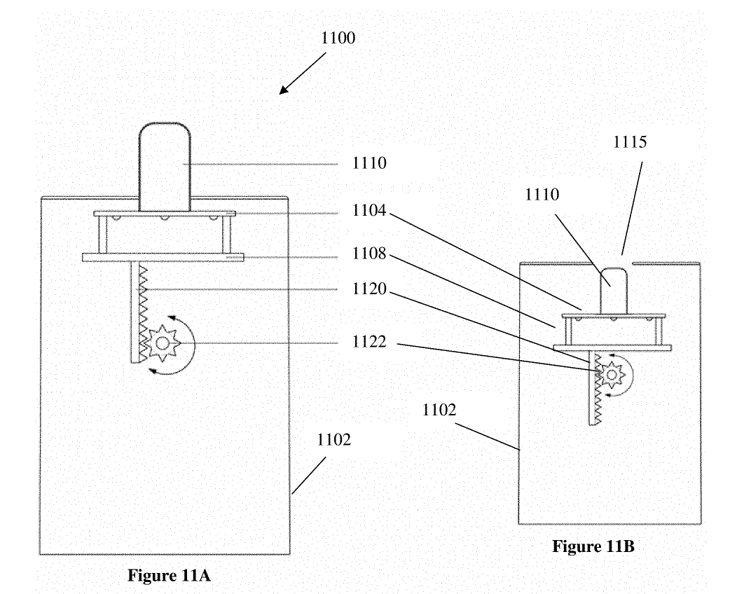

FIGS. 11A-11B illustrate another embodiment of an electronic lighting device 1100 having a retractable display screen 1110. As shown in the figures, the display screen 1110 is preferably an organic LED display (OLED), but liquid crystal displays (LCDs) and other video screens are also contemplated. A rack 1120 and pinion 1122 could be motorized and used to lift and lower the display screen 1110 on demand or per a set program, such as when the candle is turned on or off. Of course, other manners of lifting and lowering the display screen 1110 are also contemplated without departing from the scope of the invention.

Although the device is shown configured to raise or lower the PCB 1104 and the display screen 1110, in some contemplated embodiments, only the display screen 1110 may be raised, and one or more wires can electrically couple the display screen to the PCB 1104. A hole or list 1115 can be provided in an upper surface of the housing 1102 through which the display screen 1110 can rise and lower with respect to the housing 1102. Spacers 1108 or a frame can be used to connect the PCB 1104 with the rack 1120, for example. However, in other embodiments, the PCB and rack could be a single piece.

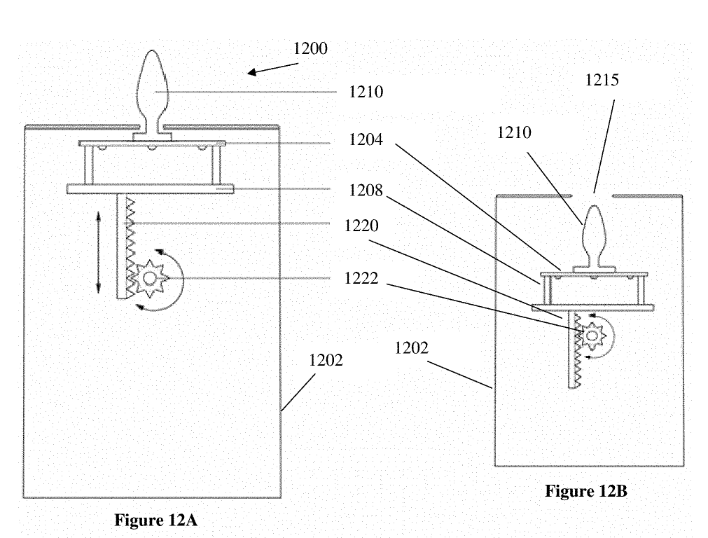

FIGS. 12A-12B illustrate another embodiment of an electronic lighting device that also has a retractable display screen having a different shape from that shown in FIGS. 11A-11B. With respect to the remaining numerals in FIGS. 12A and 12B, the same considerations for like components with like numerals of FIGS. 11A and 11B applies, respectively.

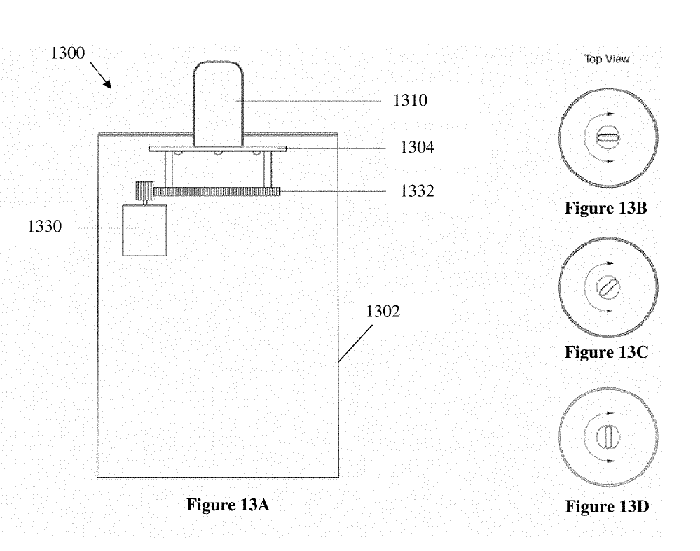

Optionally or additionally, as shown in FIGS. 13A-13D the electronic lighting device 1300 can include a motor 1330 configured to work with one or more gears 1332 to thereby rotate an orientation of the display screen 1310 with respect to the device's housing 1302. It is contemplated that the screen 1310 could automatically rotate to an orientation that faces a line-of-sight of a remote control, such that the display will always be oriented toward the user when the user transmits a command using a remote control. It is further contemplated that the screen 1310 could rotate as part of a predefined program, or per a control command of the user (e.g., rotate 90 degrees clockwise). In such embodiments, it is contemplated that the display screen 1310 and the components that allow for rotation of the display screen 1310 could all be lowered or raised as desired.

FIGS. 13B-13D illustrate various positions of the display screen 1310 after rotation.

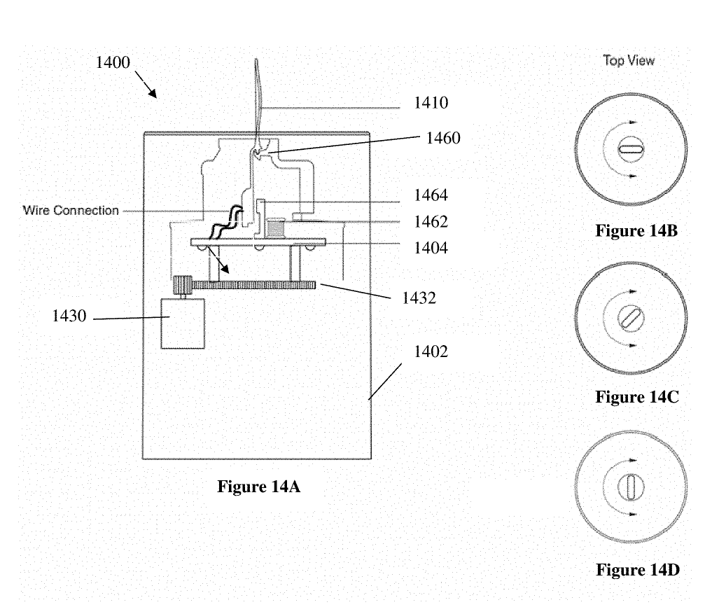

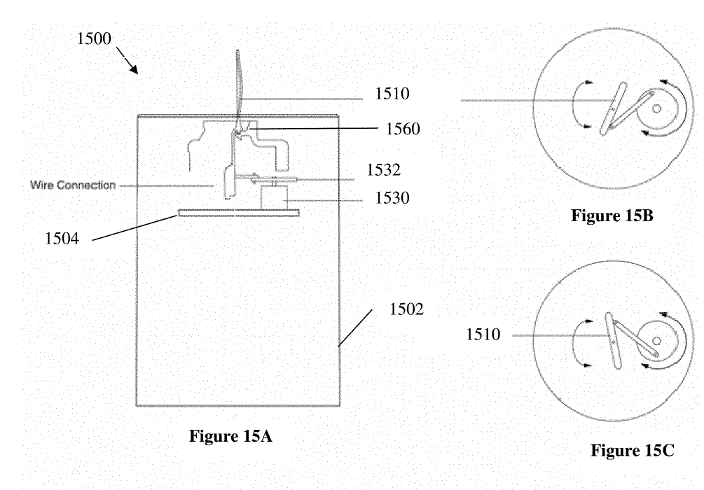

FIGS. 14A-15C illustrate various embodiments of a display screen that is movably mounted with respect to the housing, such that the display screen can move in at least two dimensions.

For example, as shown in FIGS. 14A-14D, the display screen 1410 could be pivotally mounted on a support arm 1460 that extends within the housing 1402. A coil 1462 can be configured to generate an electromagnetic field that directly or indirectly causes movement of the display screen 1410 about the support arm 1460, such as by repelling or attracting a magnet 1464 disposed on the lower portion of the display screen 1410. A more detailed discussion about the movement of a pendulum member about a support arm can be found in U.S. Pat. No. 9,335,014 issued on May 10, 2016. In addition, the device 1400 can include a motor 1430 and gears 1432 disposed within the housing 1402 such that the display screen 1410 and support arm 1460 can be rotated to thereby reorient the display screen 1410 with respect to the housing 1402. Thus, in such embodiment, the display screen 1410 can be oriented such that it faces a specific direction when at rest, while also allowing for movement of the display screen 1410 from the at rest position of the display screen 1410.

FIGS. 15A-15C illustrate another embodiment of an electronic lighting device 1500, where a motor 1530 and crank 1532 are substituted for an electromagnet and magnet to thereby cause movement of the display screen about a support arm 1560. With respect to the remaining numerals in FIG. 15A, the same considerations for like components with like numerals of FIGS. 11A and 11B applies.

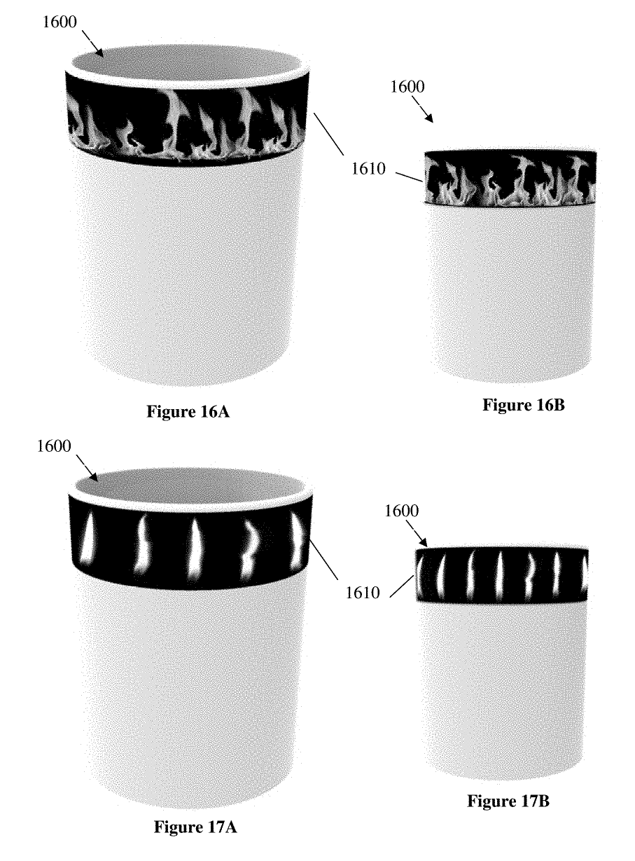

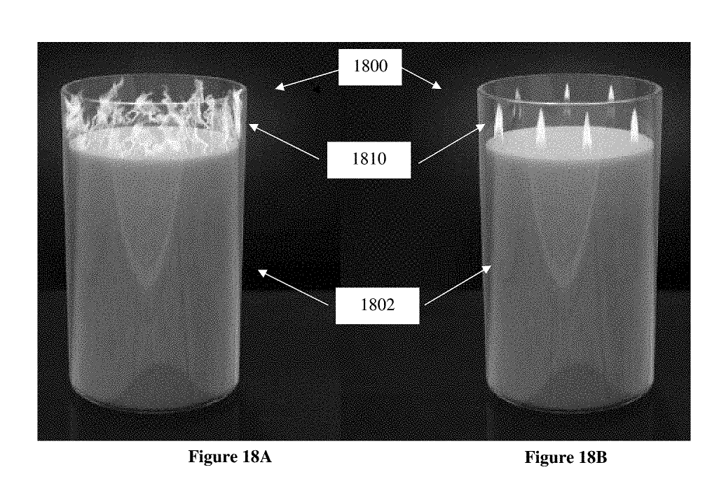

FIGS. 16A-16B and FIGS. 17A-17B illustrate another embodiment of an electric lighting device 1600 having a display screen 1610 disposed about an exterior of the device's housing 1602. In such embodiments, it is contemplated that a user will view a video of a flame regardless of an orientation of the display screen or the device 1600, and thereby could be useful in environments where the device may be used from various directions.

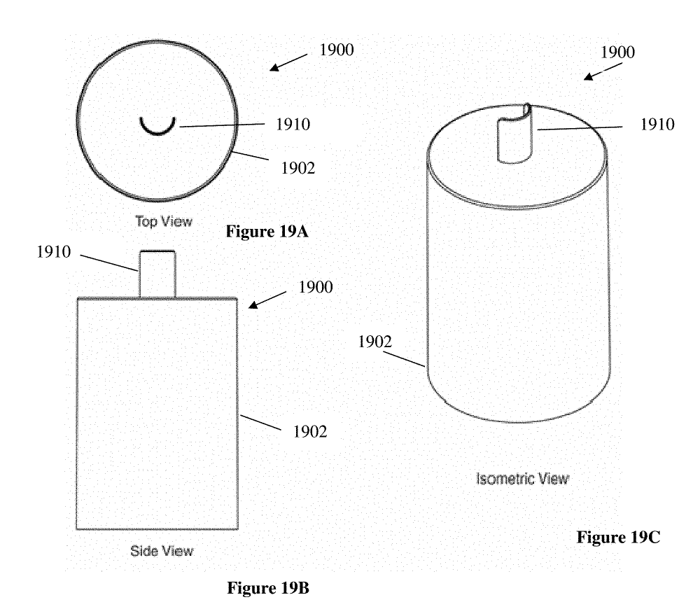

FIGS. 18A-18B illustrate another embodiment of an electric lighting device 1800 having a transparent display screen 1810 disposed about an exterior of an upper portion of the device's housing 1802. It is contemplated that using a screen that surround the outer surface, the appearance of a flame can be presented without any viewing angle restriction that exists with traditional electric candles, as the image or video is presented about the candle's housing.

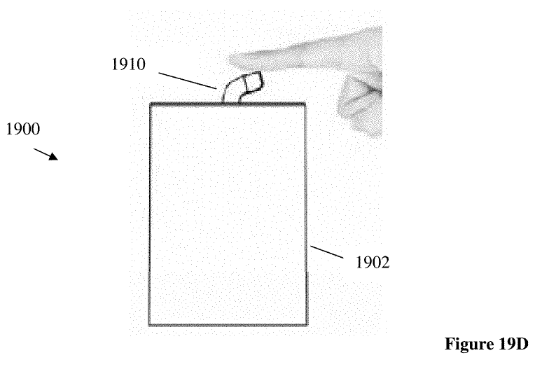

It is also contemplated that the display screen 1910 itself could be curved to form a semi-circle (e.g., 180 degrees) as shown in FIGS. 19A-19D, or a screen that is less or more than a half-circle. The effect is a greater viewing range of the flame effect by having a curved surface. In the case of the cylindrically-shaped display screen, rotation of the display screen is not needed as the effect should be visible from all sides. In such embodiments, it is further contemplated that the screen 1910 could be flexible to allow some bending or movement of the screen. This helps ensures the screen is durable and prevents breaking due to unwanted handling or movement. With respect to the remaining numerals in FIG. 19A-19D, the same considerations for like components with like numerals of FIGS. 11A and 11B applies.

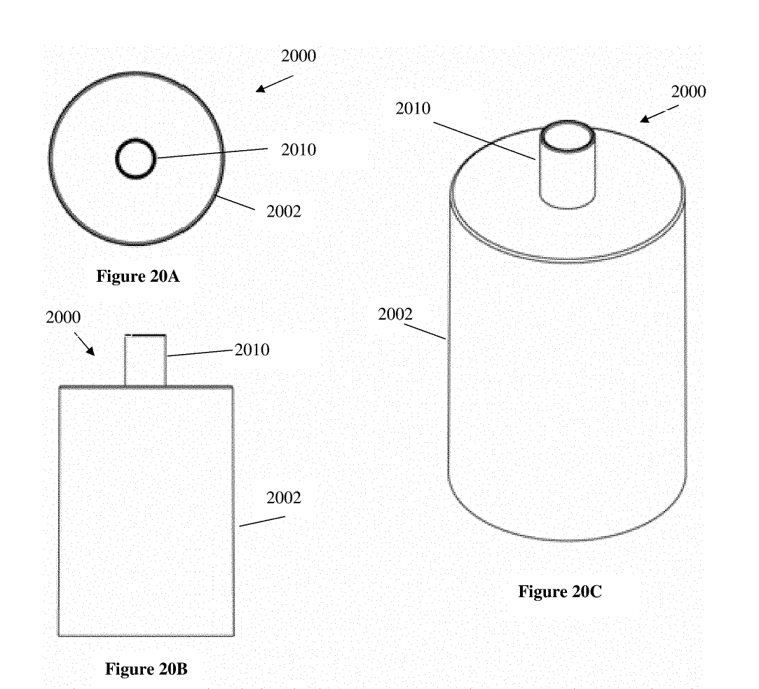

As shown in FIGS. 20A-20C, the display screen 2010 could alternatively comprise a complete or nearly complete cylinder (360 degrees). With respect to the remaining numerals in FIG. 20A-20C, the same considerations for like components with like numerals of FIGS. 11A and 11B applies.

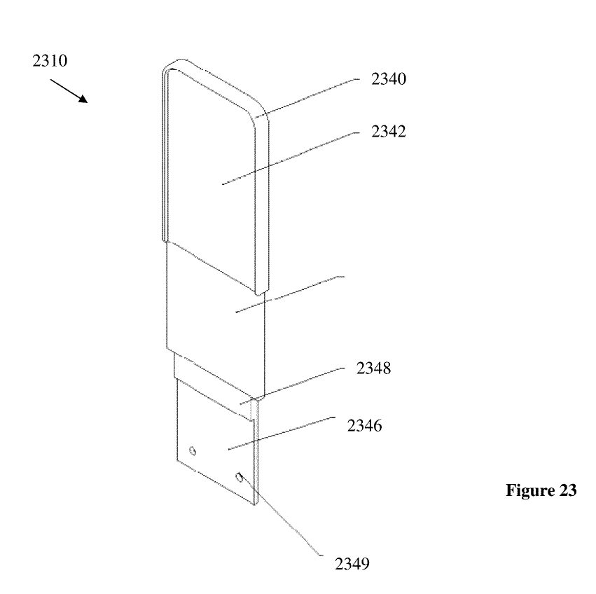

As shown in FIG. 23, the display screen 2310 as described in the various embodiments herein can include a plastic edging 2340 disposed about a clear glass 2342 that comprises the display surface of an OLED display, for example. Of course, the edging could comprise a different material so long as the material adds sufficient rigidity and mutes light output from a side of the screen 2310. A flex circuit 2346 can be connected to the display via bonding 2348 to provide power and signals to the display screen 2310. Where the display unit is to be used in an electric candle, the display unit is configured to be inserted into an aperture in an upper surface of the candle's housing, with the memory, processor and other components disposed within the candle's housing and below the upper surface and alignment holes 2349 to secure the display screen 2310 with a PCB or support surface within a housing of the device.

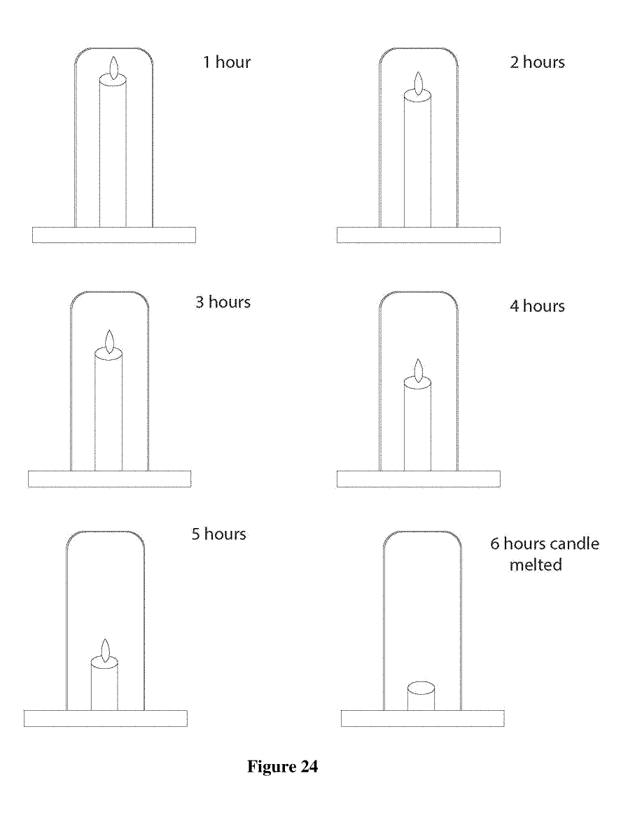

FIG. 24 is a time lapse showing still images of a video of a candle that is lit, and the melting or shrinking in height of the candle as time passes. The example shown in FIG. 24 provides a 6 hour burn of the candle, which progressively melts from that shown in the upper left corner to what is shown in the lower right corner.

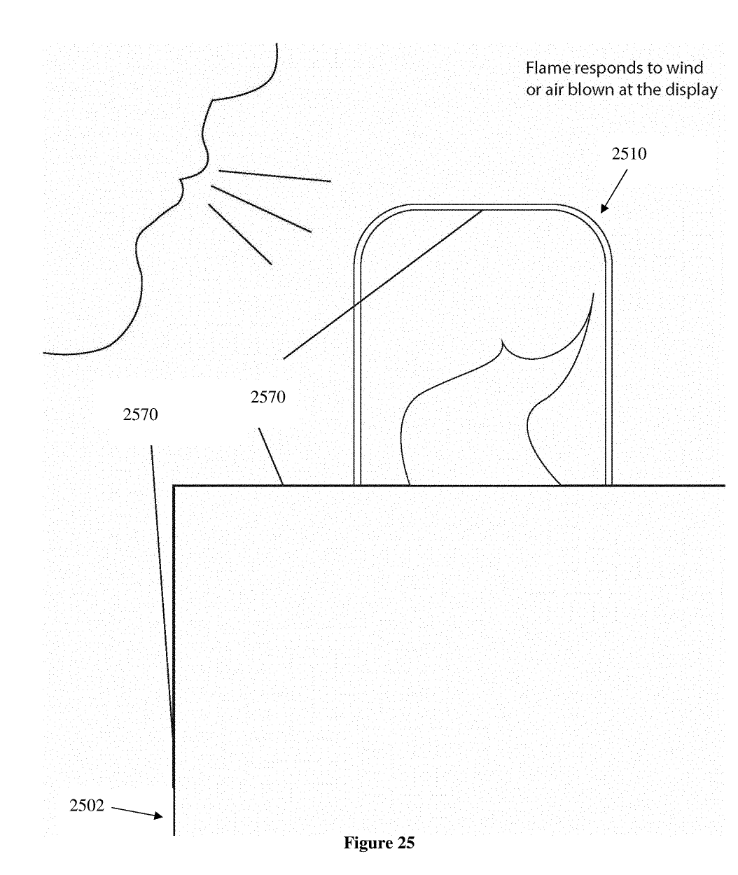

FIG. 25 is another embodiment of an electric lighting device 2500 having a housing 2502 and a display screen 2510 extending from an upper surface of the housing 2502. The device 2500 can also include one or more sail switches 2570 that generate a signal when wind or air is detected. Thus, for example, if a user were to blow air near a sail switch 2570, it is contemplated that the flame shown in the video or images can be adjusted to appear to react to the sudden airflow. It is further contemplated that the video or images could be turned off if a user blew a sufficient amount of air past the sail switch. Although three locations for sail switches are shown, it is contemplated that only a single sail switch may be included in the device.

Where the display screen comprises an electroluminescent (EL) display, there are two standard methods for dimming EL displays. Frame rate dimming allows the brightness of the display to be lowered proportionally by reducing the frame rate. Analog dimming allows the brightness to be reduced with an external, user supplied potentiometer or electronic circuitry. The brightness range for analog dimming is from 100% to nearly 5% of the full brightness. Frame rate dimming is performed within the application by lowering the frame rate of the video input signals. Because brightness is proportional to refresh rate, the display can be dimmed by adding pauses between every horizontal period. The lowest possible frame rate (brightness) is dependent on the perceived flicker of the displayed image, but could potentially be around 60 Hz.

A table of frame rates versus power consumption for EL displays is shown below.

| Frame Rate | Power Consumption % |
|---|---|
| 60 | 100 |
| 120 | 144 |
| 240 | 256 |

For OLED screens, refresh rates can be as high as 144 Hz and even 240 Hz, with frame rates typically about 60 Hz. In OLED screens, brightness is controlled by individual pixel illumination control.

Like an LED, an OLED is a solid-state semiconductor device that is 100-500 nm thick or about 200 times smaller than a human hair. OLEDs typically have 2-3 layers of organic material, with the optional third layer facilitating the transport of electrons from a cathode to an emissive layer.

OLEDs emit light via electro phosphorescence. A substrate which may comprise glass or plastic for example can be used to support the OLED. When current flows through the display, a transparent anode removes electrons, adding electron “holes”. A conducting layer comprising polyaniline or other organic plastic molecules can transport the “holes” from the anode. Finally, an emissive layer comprising polyfluorene or other organic plastic molecules different from the conducting layer transport the electrons from the cathode and thereby creates light. A cathode, which may or may not be transparent, injects electrons when a current flows through the display.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An electric lighting device, comprising:
an outer housing having an upper surface, and configured to resemble a wax candle;
a display screen extending from the upper surface; and
a PCB disposed within the outer housing, and electrically coupled to the display screen, such that an image or video can be displayed on the display screen; and
wherein the display screen is translucent or transparent when powered off.

2. The device of claim 1, wherein the display screen is transparent when in an “off” state.

3. The device of claim 1, wherein the upper surface of the housing further comprises a slot sized and dimensioned to allow the display screen to move through the slot to retract all or some of the display screen within the housing.

4. The device of claim 3, further comprising a rack and pinion disposed within the housing, wherein rotation of the pinion causes movement of the rack and thereby causes the display screen to be lowered within the housing through the slot.

5. The device of claim 3, wherein the PCB comprises the rack.

6. The device of claim 5, wherein rotation of the pinion further causes the PCB to move within the outer housing.

7. The device of claim 1, wherein the display screen comprises an OLED display.

8. The device of claim 1, wherein the display screen is pivotally mounted within the outer housing such that the display screen can move in at least two dimensions.

9. The device of claim 8, wherein the display screen comprises a magnet, and wherein the PCB comprises an electromagnetic coil configured to generate an electromagnetic field that interacts with the magnet and causes movement of the display screen with respect to the outer housing.

10. The device of claim 1, wherein the display screen is disposed on a moveable platform, and wherein the platform is coupled to a motor via one or more gears, such that rotation of the gears by the motor causes the display screen to turn, thereby causing the display screen to reorient with respect to the outer housing.

11. The device of claim 1, further comprising a sail switch configured to send a signal to a processor disposed on the PCB, and wherein the processor is configured to alter an image or video of the flame that is presented on the display screen.

12. The device of claim 11, wherein the processor is configured to alter the image or video of the flame as a function of the airflow detected.

13. The device of claim 11, wherein the processor is configured to power off the display screen as a function of the signal received.

14. The device of claim 1, further comprising a transceiver configured to wirelessly receive an updated video or image to display on the display screen.

15. A display unit for an electric candle, comprising:
a clear display surface;
an edging disposed at least partially about the clear display surface; and
a flex circuit coupled to the display surface and configured to provide power and signal to the display surface such that an image or video of a flame can be presented on the display surface.

16. The display unit of claim 15, wherein the display surface comprises an OLED display.

17. The display unit of claim 15, wherein the display surface is transparent when powered off.

18. The display unit of claim 15, wherein the display surface is curved.

19. The display unit of claim 15, wherein the edging is opaque to mute light output from a side of the display surface where the edging is placed.
